(19) United States
(12) Patent Application Publication
(10) Pub. No.: US 2015/0199673 A1
(43) Pub. Date: Jul. 16, 2015

(54) METHOD AND SYSTEM FOR SECURE PASSWORD ENTRY

(71) Applicant: iAXEPT Ltd, Surrey (GB)

(72) Inventors: Risto Kalevi SAVOLAINEN, London (GB); Stephane JAYET, Meyzieu (FR)

(21) Appl. No.: 14/597,436

(22) Filed: Jan. 15, 2015

Related U.S. Application Data
(60) Provisional application No. 61/927,536, filed on Jan. 15, 2014.

(51) Int. Cl. G06Q 20/32; G06Q 20/34; G06Q 20/40

(52) U.S. Cl. CPC G06Q 20/3226; G06Q 20/4012; G06Q 20/3278; G06Q 20/40; G06Q 20/352

(57) ABSTRACT

The embodiment(s) relates to a method and system for authenticating a user conducting a payment card transaction using a payment card. The method includes comparing, in a secure element containing secured data including a first code and first payment card information associated with the first code, or a mobile device to which the secure element is connected, the first code with a second code provided as an entry at the mobile device, and the first payment card information with second payment card information of the payment card read from the payment card via a card reader of the mobile device when the payment card is near the card reader of the mobile device. The method includes transmitting user authentication information associated with the first code for conducting the payment card transaction when there is a match between the first and second codes and the first and second payment card information.

### CROSS REFERENCE TO RELATED APPLICATIONS

This application is based on and claims priority to U.S. Provisional Patent App. No. 61/927,536, filed on Jan. 15, 2014 with the U.S. Patent Office, the contents of which priority application are hereby incorporated by reference in their entity.

### BACKGROUND OF THE INVENTION

1. Field of the Invention

The invention relates to contactless chip payment cards, and secure Personal Identification Number (PIN) code entry using contactless chip payment cards.

2. Description of the Related Art

Mobile devices, such mobile phones, smart phones, personal computers, set top boxes, automotive dashboard computers and tablet computers can be used for financial transactions, such as credit card payments. This functionality is known generally as Mobile Payment or Mobile Commerce.

A mobile device can run several software applications in the same fashion as computers, and there is a risk that some of the applications the users are downloading from the Internet may contain unwanted code or hidden functionality (“Malware”) which could detect, record, and misuse private and sensitive information, such as credit card numbers and PIN codes.

Current methods implement a contactless mobile Point of Sale (POS) terminal as software in a mobile device or in a Subscriber Identity Module (SIM) card, which is inserted into the mobile phone, and implement external card readers and PIN pads connected to the mobile device either via wireless Local area Network (WLAN), Bluetooth© or plugged into device headset connector. The mobile POS terminal can use the phone as a card reader for Near Field Communication (NFC) and other contactless cards, as well as a display and a keypad for user input and as a modem to connect to a payment processing system.

Like the Europay, MasterCard, and Visa (EMV) credit cards with an embedded integrated circuit (IC), Universal Integrated Circuit Card (UICC)/SIM cards used in mobile devices are tamper evident and designed to meet high security standards fulfilling the criteria for financial transactions.

A problem that arises with respect to using a mobile phone for payment transactions, the mobile phone including the operating system software, hardware, and applications running in the memory of the mobile phone, is not considered secure enough for entering a secret credit card PIN code and/or passwords for financial transactions. Malware software could monitor and record the keystrokes or touch screen activity when the user is typing the PIN code, copying a user's on-screen signature, recording voice commands or generally capturing any activity the user may do to interact with the device and its operating system.

The cardholder verification PIN code used for card payments can be captured by a software application running in the phone before it reaches the POS application. Therefore, the mobile phone cannot be trusted as a PIN entry device.

Contactless payment cards are available, such as Contactless EMV cards with an NFC interface, which allow the contactless payment card to interact with a contactless card reader without a physical contact. This feature enables very fast and convenient payment transactions. In some instances, card issuers accept that contactless payments below a certain threshold value can be allowed without the user verification PIN code. However, this may lead to a situation where a stolen contactless card could be used multiple times at or below the threshold level without ever needing to know or enter the secret PIN code.

As a countermeasure, the Contactless EMV cards have implemented a counter, which forces the user to enter the PIN code after a certain number of repeated contactless transactions occur without using the PIN code. In practice, the cardholder then needs to use a POS terminal with a traditional chip card reader (ISO contacts) and insert the card in the card reader to complete the transaction with the PIN code to reset the non-PIN transaction counter. If the POS terminal does not have a certified PIN entry pad or a contact card reader, this could lead to a dead-lock situation where the contactless card requires the PIN code to continue operational, but the POS terminal is not capable of handling the PIN entry.

In the case of a transaction with a value above the threshold, i.e. which could not be conducted without the PIN code, the only option is to use a POS terminal with contact card reader and a certified PIN entry pad. Mobile device-based POS terminals without a secure PIN Entry Device could not handle such transactions. The risk is that the credit card or the card information including the PIN code could be stolen or captured, and together those could be used for committing fraudulent purchases.

### BRIEF SUMMARY OF THE INVENTION

The embodiment(s) relate to contactless chip payment cards and secure PIN code entry with a POS terminal application running on an Embedded Secure Element (“ESE”) of a mobile device or on a UICC/SIM card (“UICC Card”) inserted in a mobile device, which supports a short distance communication method, such as NFC.

Instead of using the phone's keypad or touch screen display or an external PIN entry device for providing the cardholder verification PIN code, the present embodiment(s) creates a secured PIN code (a pseudo PIN code-PIN2) combined with an actual credit card PIN code (true PIN code), a credit card number, and a mobile phone number, and securely delivers the data to and stores it in the UICC (SIM) card in a mobile device. Furthermore, the present embodiment(s) enables the cardholder to conduct a contactless credit card transaction requiring a PIN code, and instead of the actual PIN code, enter the pseudo code (PIN2) on the mobile device and to the POS software residing on, e.g., the UICC card. The POS software will verify whether the user-provided pseudo PIN code (PIN2) matches the stored PIN code (PIN2) for the used credit card, it will, if required, encipher the actual PIN code and send it to the contactless credit card or to a payment processing system as a cardholder verification.

The present embodiment(s) guarantees that the payment card's true PIN code is never exposed in clear text format, but it is always encrypted in a security certified device or is stored in a secured chip card memory.

In one or more embodiments, a method for authenticating a user conducting a payment card transaction using a payment card is provided. The method includes comparing, in one or more of a secure element containing secured data including at least one first code and at least one first payment card information associated with the first code, and a mobile device to which the secure element is connected, the first code with a second code provided as an entry at the mobile device to determine whether or not there is a match between the first code and the second code, and comparing the first payment card information with second payment card information of the payment card read from the payment card via a card reader of the mobile device to determine whether or not there is a match between the first payment card information and the second payment card information when the payment card is in the vicinity of the card reader of the mobile device. The method also includes transmitting, by a transmission device from the mobile device, user authentication information for conducting the payment card transaction when it is determined that there is a match between the first code and the second code and it is determined that there is a match between the first payment card information and the second payment card information.

In one or more embodiments, a method of enabling a user to conduct a payment card transaction is provided. The method includes receiving an entry of a pseudo personal identification number (PIN) code in connection with a payment card, at a secure element connected with a mobile device, and obtaining user authentication information including a true PIN code associated with the pseudo PIN code. The method also includes transmitting, via a transmission device, the user authentication information confirming user authentication to authorize use of the payment card in a payment transaction, to the payment card or to an external authorization service or system.

In one or more embodiments, a system for enabling a user to conduct a payment card transaction is provided. The system includes a contactless payment card, a mobile device, a secure element, and a transmission device. The contactless payment card is configured to communicate via short distance communication. The mobile device includes one or more user interface components configured to receive an entry of a second code, and a card reader configured to read information from the payment card. The secure element is configured to communicate with the mobile device. The secure element receives and stores secured data including at least one first code and at least one first payment card information associated with the first code, and receives the second code from the mobile device. The secure element includes one or more processors executing a transaction authorization application. The transaction authorization application obtains user authentication information when the second code is compared with the stored first code that is associated with the payment card and a match is determined to be made between the first code and the second code, and when the stored first payment card information is compared with second payment card information read from the payment card via the card reader of the mobile device and a match is determined to be made between the stored first payment card information and the second payment card information read from the payment card via the card reader when the payment card is in the vicinity of the card reader of the mobile device. The transmission device is configured to transmit the user authentication information to one of the payment card and a payment processing system as user verification for conducting a transaction using the payment card with the mobile device.

### BRIEF DESCRIPTION OF THE DRAWINGS

Other objects and advantages of the present embodiments will become apparent from a study of the following specification when viewed in the light of the accompanying drawings, in which:

FIG. 1 is a schematic diagram of a contactless payment card, a secure element, and a mobile phone according to at least one embodiment;

FIG. 2 is a schematic diagram of a contactless payment card, a secure element, a mobile phone, and a payment processor according to at least one embodiment;

FIG. 3 is a schematic diagram of the contactless payment card, the mobile phone, and a payment processor according to at least one embodiment;

FIG. 4 is a schematic illustration of a transaction flow with the contactless payment card, a POS terminal application, a PIN application, a mobile phone, and an issuer/acquirer bank according to at least one embodiment;

FIG. 5 is a schematic illustration of a transaction flow with the contactless payment card, a POS terminal application, a PIN application, a mobile phone, and an issuer/acquirer bank according to at least one embodiment;

FIG. 6 is a schematic illustration of a transaction flow with the contactless payment card, a POS terminal application, a PIN application, a mobile phone, and an issuer/acquirer bank according to at least one embodiment;

FIG. 7 is a schematic diagram illustrating creation and delivery of a PIN certificate according to at least one embodiment;

FIG. 8 is a schematic diagram illustrating creation and delivery of a PIN certificate according to at least one embodiment;

FIG. 9 is a schematic diagram illustrating creation and delivery of a PIN certificate according to at least one embodiment;

FIG. 10 is a schematic diagram illustrating creation and delivery of a PIN certificate according to at least one embodiment; and

FIG. 11 is a block diagram of a UICC card according to at least one embodiment.

### DETAILED DESCRIPTION OF THE INVENTION

Reference will now be made in detail to the preferred embodiments of the present invention, examples of which are illustrated in the accompanying drawings, wherein like reference numerals refer to like elements throughout.

The present embodiment(s) solves the above-described problem of unwanted exposure of the true PIN code, by typically encrypting the true PIN code in a security certified device before transmitting it and by storing the true PIN code in a secured chip card memory. The present embodiment(s) enables full tracing of the PIN code using security certificates based on cryptographic algorithms, such as Public Key Infrastructure (PKI).

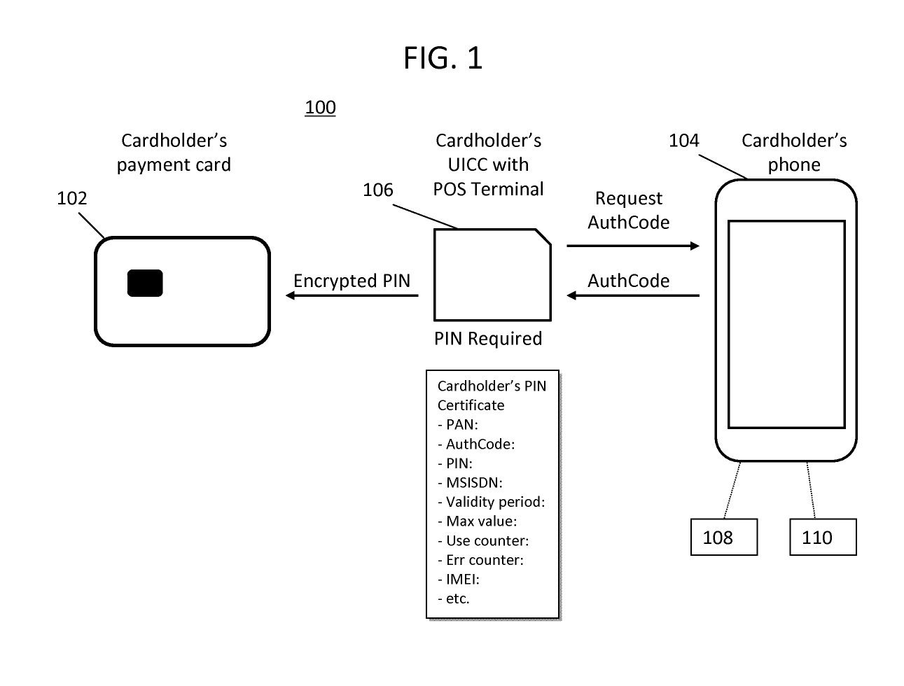

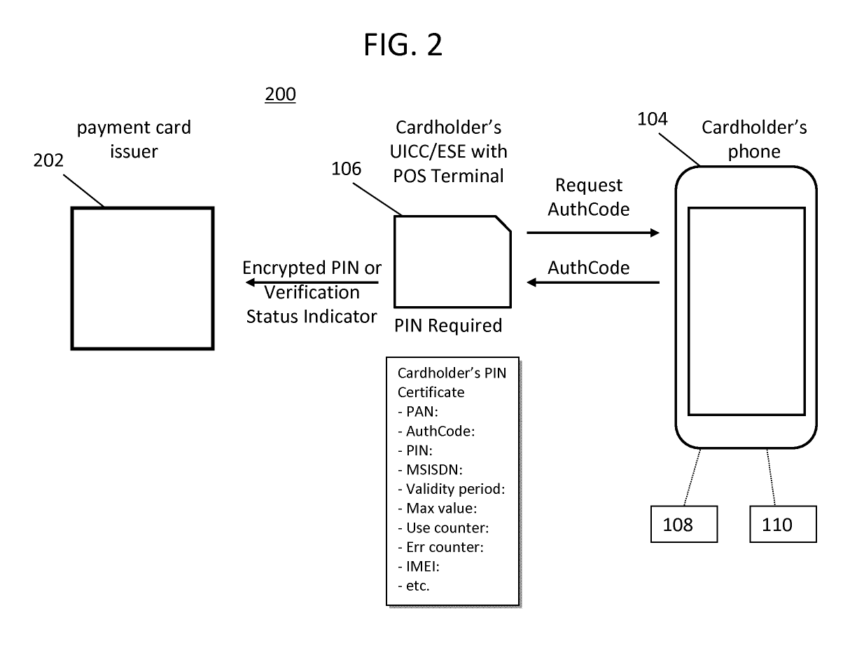

Turning now to FIG. 1, FIG. 1 is a schematic diagram illustrating a system 100 including a contactless payment card 102, a mobile device 104, and a secure element 106. FIG. 2 is a schematic diagram illustrating a system 200 including the contactless payment card 102, the mobile device 104, the secure element 106, and a payment card issuer 202. The mobile device 104 may include, but is not limited to, a cellular phone, a mobile tablet, a personal digital assistant, a personal communicator, a pager, a smart phone, or any other handheld computing device. The mobile device 104 includes a card reader 108 configured to read the contactless payment card 102 and a transmission device 110. The secure element 106 may be a Universal Integrated Circuit Card (UICC) that is connected to the mobile device 104, typically by being inserted into the mobile device 104. The secure element 106 may be an embedded secure element (ESE) connected with the mobile device 104 by being embedded within the mobile device 104 itself. The secure element 106 contains secured data, which has obtained in a manner described in more detail below. The secured data includes at least one first code, which may be a PIN code, and at least one first payment card information associated with the first code. The secured data may also include another code, which is a true PIN code.

When a user wants to use the payment card 102, the user is authenticated by inputting a second code (e.g., PIN2 code) to the mobile device 104. The PIN code is a pseudo PIN code and is not the actual (true) PIN code associated with the contactless payment card 102. The user enters the PIN code (PIN2) using a provided user interface running on the mobile device 104. The user-input PIN code (PIN2) is forwarded to a PIN/authorization application or Point of Sale (POS) application running on the secure element 106.

Thereafter, the POS application on the secure element 106, either alone or in conjunction with the mobile device 104, verifies whether the user-entered PIN2 code matches the code it received as secured data, which may include enciphered PIN data. The POS application at the secure element 106 also compares first payment card information stored as part of the secured data with second payment card information of the payment card 102 read from the payment card via the card reader 108 of the mobile device 104 to determine whether or not there is a match between the first payment card information and the second payment card information when the payment card 102 is in the vicinity of the card reader 108 of the mobile device 104. The term “in the vicinity” corresponds with being in a readable area of the card reader 108 of the mobile device 104 such that the card reader 108 is able to read information from the payment card 102.

If the verification between the PIN codes and the payment card information is successful (i.e., there is a match between the entered code and the stored code and there is a match between the read payment card information and the stored payment card information), the POS application provides user authentication information for conducting a payment card transaction that is transmitted by the transmission device 110 from the mobile device 104. The POS application retrieves data, such as a true PIN code (e.g., a third code) securely stored in a memory, enciphers the true PIN code, and provides the enciphered PIN code. The true PIN code may be stored as plain text in a secured memory or as encrypted text in a non-secure memory. The user authentication information may include the enciphered actual (true) PIN code (e.g., a third code). The user authentication information, which may include the enciphered PIN code, may be transmitted to the contactless payment card 102 for local validation (FIG. 1). The user authentication information, which may include the enciphered PIN code, may be transmitted to a payment processing system 202, illustrated in FIG. 2, for online validation. The user authentication information may include a user verification status indicator, which may be transmitted to the payment processing system 202 (FIG. 2).

The true PIN code (the third PIN code) linked with an account for the payment card 102, e.g., through a primary account number (“PAN”), and the secret, second PIN code (PIN2) may be created using a security certified device or system, such as an ATM or by a bank. The second PIN code (PIN2) may be signed by the issuer of the payment card 102 and encrypted.

The user authentication information, which includes the enciphered PIN data, can contain also other information, such as counter, expiration date, payment card number, and POS UICC card identification. The enciphered PIN data can be sent to the secure element 106, e.g., the POS UICC card of the mobile device 104 or the embedded secure element (“ESE”) embedded in the mobile device 104, over any available network, short distance communication method, such as NFC, via the mobile device 104 or by using the card reader 108. The payment card's PIN and PIN2 codes are residing in the same secure element (e.g., the smart card IC on the POS UICC) as the POS terminal application. Thus, the true PIN code for the payment card 102 is never outside a secured, tamper-evident device or chip card in clear text format

Thus, when the contactless payment card 102 is used in conjunction with the mobile device 104 with a POS application on a secure element 106, such as the UICC card or the ESE, and a PIN code is required for cardholder verification, the cardholder can enter the second PIN code (PIN2) instead of the actual PIN code (third code) of the payment card 102.

As a result, the PIN2 code can be used for cardholder verification only for the registered cardholder's payment card 102 used in conjunction with the cardholder's mobile device 104 holding the secure element (e.g., the cardholder's UICC card or embedded secure element embedded in the mobile device 104. In other words, capturing and stealing the PIN2 code does not allow the payment card 102 to be used, for example, at an ATM to withdraw cash from the cardholder's bank account or to allow any purchases or cash-back transactions using the card at a Point of Sale terminal.

The present embodiment(s) guarantees that the payment card's PIN code is never outside a secured, tamper evident device or chip card in clear text format, i.e. not encrypted, and also that the user never needs to type the actual card PIN number on the mobile phone 104.

Consequently, the present embodiment(s) significantly increases the security level and decreases fraudulent use because the actual payment card PIN code is never used with the mobile phone-based POS terminal. Therefore, capturing the PIN code, for example by malware running in the mobile device 104, cannot be used in conjunction with the payment card 102 at an ATM, at a POS terminal in a shop, etc.

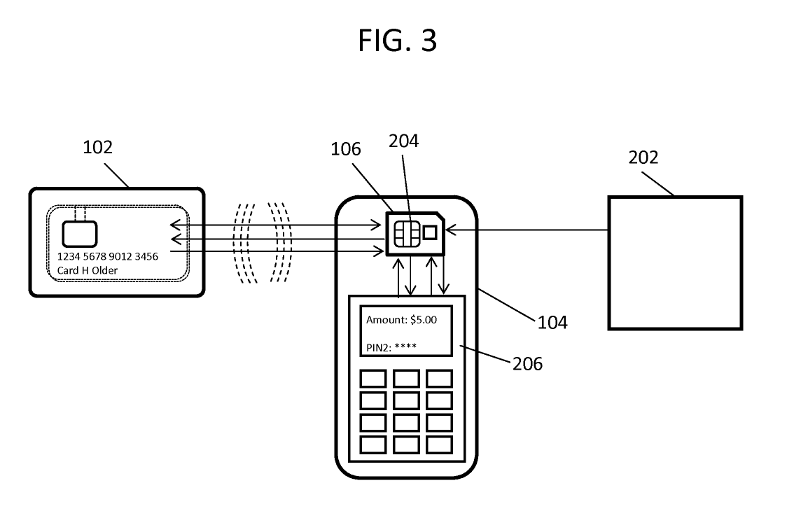

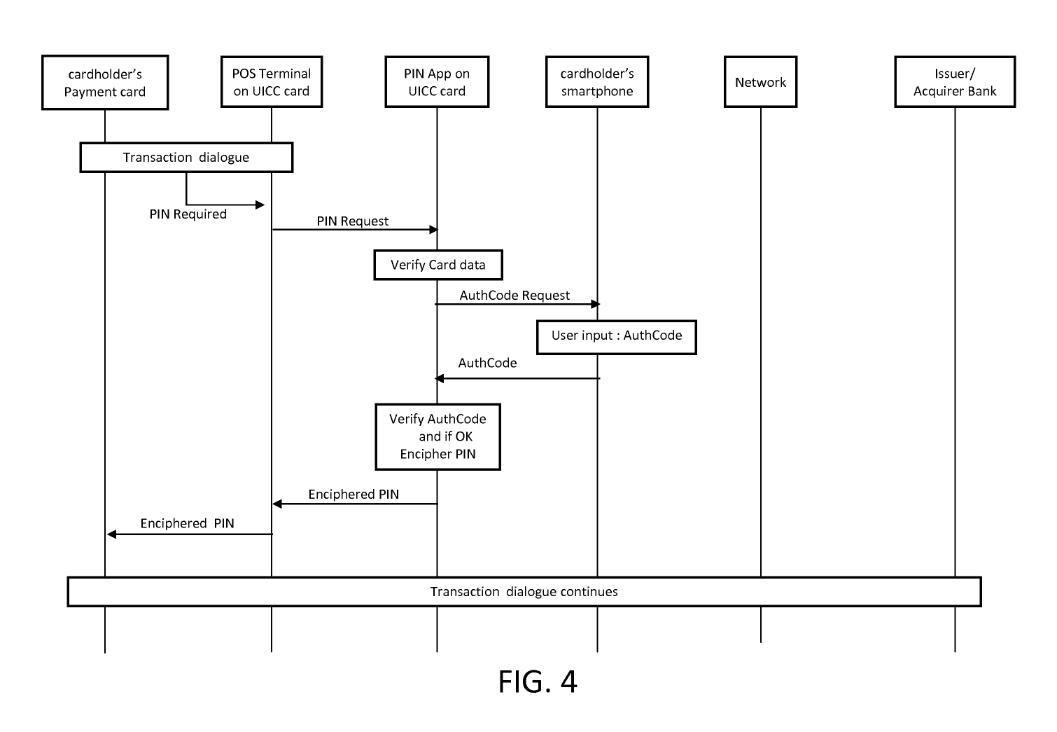

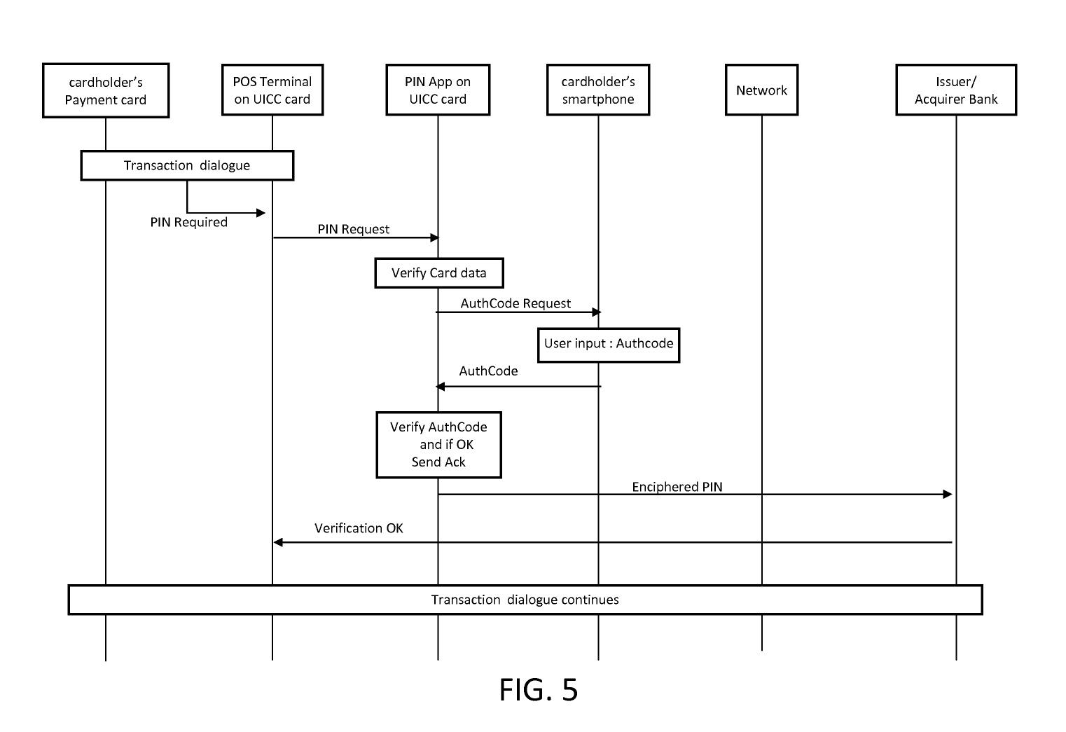

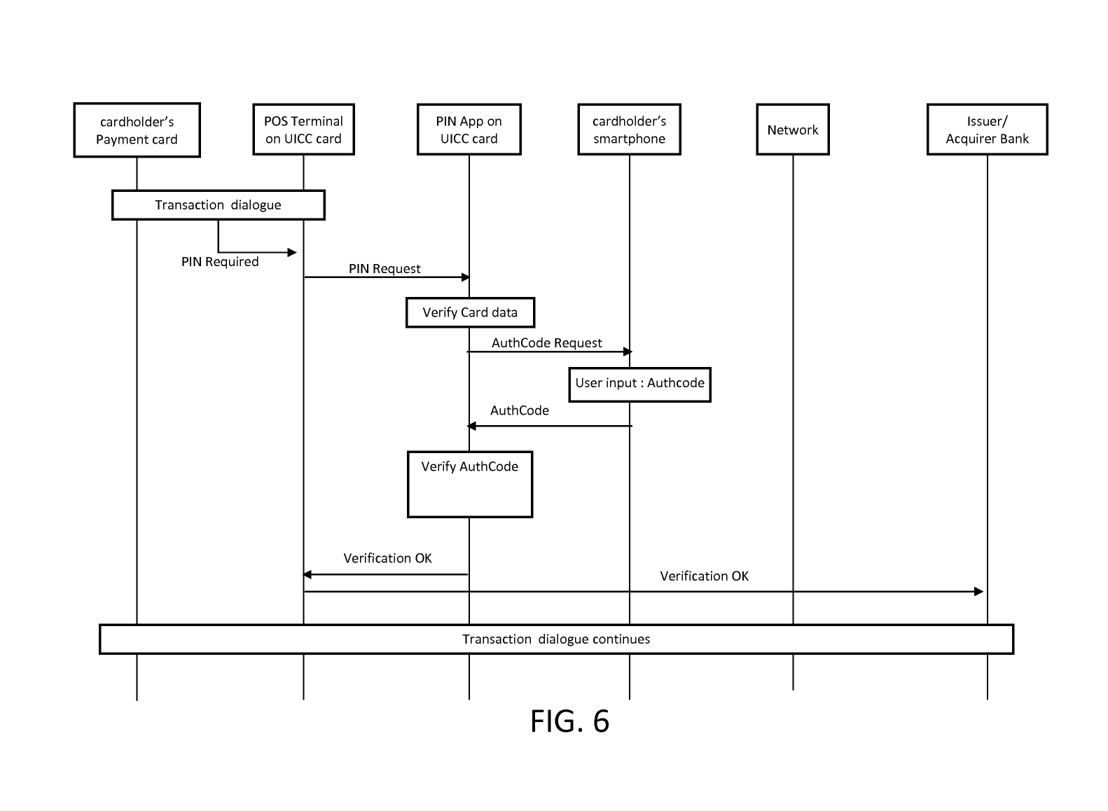

Turning now to FIGS. 3-6, FIG. 3 is a diagram of the contactless payment card 102, the mobile phone 104, and the payment processor 202 according to at least one embodiment. FIG. 3 is an example of a payment transaction in accordance with at least one embodiment. FIG. 4 is a schematic illustration of a transaction flow with the contactless payment card, a POS terminal application, a PIN application, a mobile phone, and an acquirer bank according to at least one embodiment. FIG. 5 is a schematic illustration of a transaction flow with the contactless payment card, a POS terminal application, a PIN application, a mobile phone, and an issuer/acquirer bank according to at least one embodiment. FIG. 6 is a schematic illustration of a transaction flow with the contactless payment card, a POS terminal application, a PIN application, a mobile phone, and an issuer/acquirer bank according to at least one embodiment.

The payment processor (“PP”) 202 may receive the cardholder's phone number and fixed payment instruction including a merchant's remote POS terminal profile from a merchant. The PP 202 signs the Remote Payment Instruction with its secret key, encrypts it with a public POS Certificate key corresponding to the cardholder's phone number of the mobile phone 104, and sends it to the POS application 204 on the secure element 106, which may be a UICC card of the cardholder's mobile device 104 or an embedded secure element (ESE) embedded in the cardholder's mobile device 104, using the cardholder's phone number.

The POS application 204 on the secure element 106 receives the Remote Payment Instruction, decrypts it with its secret key and validates it with the PP's 202 public key. The POS application 204 interacts with a User Interface application 206 on the cardholder's mobile device 104 and displays the payment information for cardholder's approval or dismissal. The User Interface application 206 sends the cardholder's approval to the POS application 204.

The POS application 204 activates the mobile device's NFC interface and begins the payment transaction process with the cardholder's payment card 102. The POS application 204 reads information from the card 102, including the card number, cardholder's name, and public PIN enciphering key, etc. depending on the payment card 102.

A cardholder verification (authentication) PIN code is required by the POS application 204 at the secure element 106 or by the payment card 102. The POS application 204 requests a PIN code verification from a PIN application, which may be included in the POS application or may be separate from the POS application. The PIN application retrieves the payment card's registered PIN from its memory and requests a secret PIN code (PIN2) from the cardholder using the User Interface application 206.

The cardholder enters the PIN2 code on the User Interface application 206 at the mobile phone 104, and the User Interface application 206 returns the PIN2 code to the PIN application running on the secure element 106. Thereafter, the PIN application verifies the PIN2 code and the payment card number, and if the PIN2 code and the payment card number are verified successfully by matching with a stored code and payment card number, the PIN application enciphers a corresponding PIN code with the payment card's PIN enciphering key and returns the enciphered PIN code (e.g., the third code) to the POS application 204, which will forward the enciphered PIN code to the cardholder's payment card 102 for cardholder verification (FIG. 4). The payment card 102 recovers and verifies the PIN code with its PIN enciphering key, and either accepts or declines the payment and sends the result to the POS application 202 for further processing.

Alternatively, as shown in FIG. 5, when the second code (PIN2) and the payment card number are verified, the PIN application enciphers a corresponding PIN code associated with the PIN2 code and transmits the enciphered PIN code to the issuer/acquirer bank (payment processing system) 202, which provides verification to the POS application 204.

In another alternative, as shown in FIG. 6, when the second code (PIN2) and the payment card number are verified, the PIN application may provide the POS application 204 with an indication that the user verification is satisfied. The POS application 204 may transmit a user verification status indicator to the issuer/acquirer bank (payment processing system) 202.

While the POS application and the PIN application are described above as two separate applications, the POS application and the PIN application can be integrated in the same application.

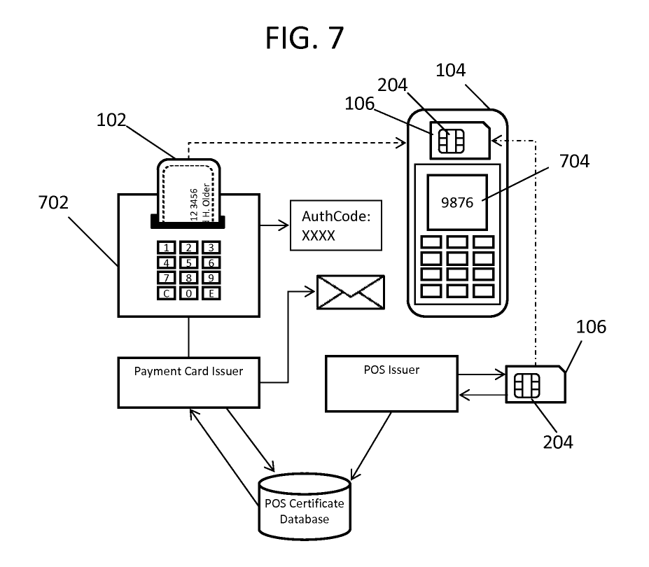

Turning now to FIGS. 7-10, FIGS. 7-10 illustrate the creation and delivery of the PIN certificate, which may store the secured data, including the PIN2 code.

The PIN certificate contains various types of information associated with the payment card 102. The PIN certificate may contain, for example, a payment card number (e.g, a Primary Account Number), the true PIN code, the pseudo PIN code (PIN2), a validity period, processing restrictions (e.g., value, usage counter, error counter, currency, country, card version, POS version, host device, etc.), issuer information, the date of issuance, and the issuer's signature.

The second code (PIN2) is provided from one or more stored secured data, each of the stored secured data being associated with a different condition associated with use of the payment card 102. The different condition for a specific stored secured data includes one or more of: (1) a value limit on the transaction associated with the user authentication, (2) a threshold level of transactions using only the payment card 102, (3) the transaction involving currency that is not indicated at an authentication application as domestic currency, (4) the transaction occurring in a foreign country to a home country of the payment card 102 or a home country of the mobile device 104, (5) the transaction being a forced transaction, and (6) a single-code transaction in which the stored secured code expires after the single-code transaction occurs.

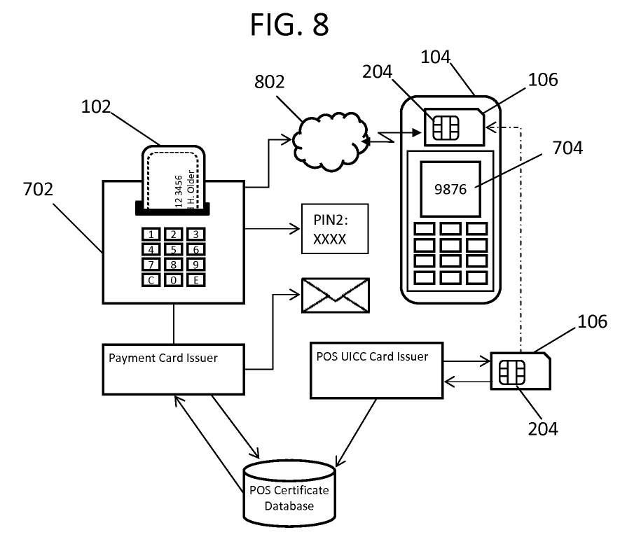

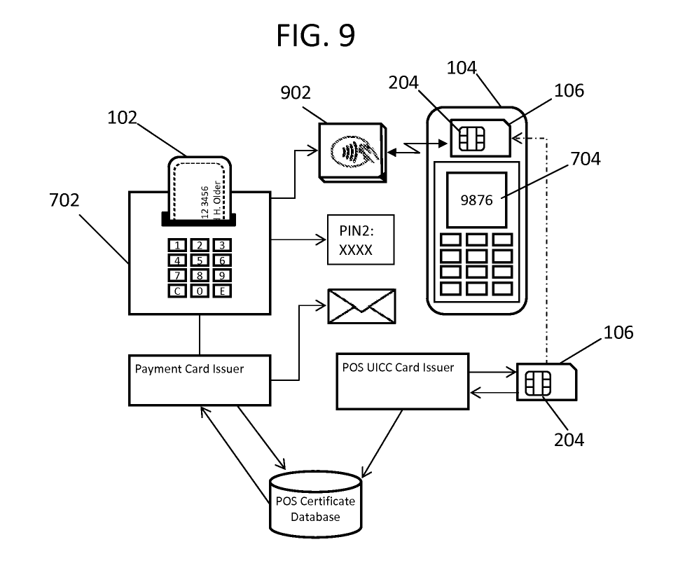

The secured data may be received via one or more of a mobile/cellular network (see FIG. 8), the Internet, a wireless or wired local area network, a cable connected to the mobile device 104, a memory card, a short distance communication interface (see FIG. 9), an embedded camera in the mobile device 104, a microphone, another audio interface of the mobile device 104, a keypad of the mobile device 104, and a touchscreen of the mobile device 104.

FIG. 7 is a schematic diagram illustrating creation and delivery of a PIN certificate using the payment card 102 as the delivery media.

A POS Issuer installs a POS application 204 into the secure element 106 (e.g., the UICC Card) and launches POS enciphering key pair generation the secure element 106. The POS Issuer receives and verifies the initial POS Certificate, updates it with the phone number of the mobile phone 104 (MSISDN) and signs the updated POS Certificate with the POS Issuer's Secret key. The POS Issuer stores the POS Certificate (including MSISDN) in the POS Certificate database.

The cardholder inserts in a card terminal 702 the card 102 to be registered with the POS application 204, and reads the Primary Account Number, the public IC PIN enciphering key, the cardholder's name, etc. The cardholder is verified by the PIN code (PIN2) entered using the keypad of the card terminal 702 and the payment card's Primary Account Number (PAN). The cardholder enters the mobile phone number of the secure element 106, e.g., the POS UICC card (MSISDN). The card terminal 702 or the Card Issuer requests the POS certificate using the MSISDN number. The card terminal 702 or the Card Issuer receives the UICC POS certificate and validates it by using the POS Issuer's public key.

The card terminal 702 generates an unpredictable number, encrypts the number with the public POS key and send it to the POS application 204 on the secure element 106, e.g., UICC card, using the MSISDN number. The POS application 204 receives the encrypted data, decrypts the number, and presents the recovered unpredictable number on a display 704 of the mobile device 104.

The cardholder and owner of the mobile device 104 enters the unpredictable number on the card terminal 702 for proof of having the mobile device 104 with the UICC card corresponding with the MSISDN number. In the alternative, Near Field communication may be used to verify the phone 104 with the POS app 204 on the secure element 106 at the card terminal 702.

The card terminal 702 verifies the sent and user typed unpredictable numbers, and as a result, either proceeds or declines. The card terminal generates the pseudo code (PIN2), signs the POS PIN Certificate (MSISDN, PAN, PIN, PIN2) with a card issuer's secret key and encrypts it with a public POS key. The card issuer sends the encrypted and signed POS PIN Certificate to the secure element 106, e.g., UICC card, using the MSISDN number. The secure element 106 receives the encrypted POS PIN Certificate and decrypts it with its secret POS key, verifies the card issuer's signature, and stores the POS PIN Certificate in the secure element's secure memory. The card issuer then sends the PIN2 code by secure mail to the cardholder's correspondence address.

FIG. 8 is a schematic diagram illustrating creation and delivery of a PIN certificate using a network 802 as the delivery method to the to the POS application 204 on the secure element 106 (e.g., the UICC card).

FIG. 9 is a schematic diagram illustrating creation and delivery of a PIN certificate using a NFC contactless card reader 902 as the delivery media to the POS application 204 on the secure element 106 (e.g., the UICC card).

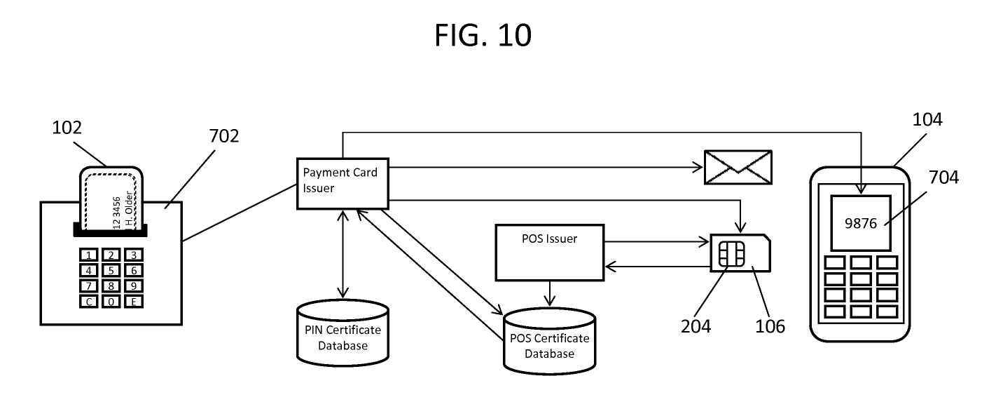

FIG. 10 is a schematic diagram illustrating creation and delivery of a PIN certificate using the payment card 102 as the delivery media with a feedback loop for proving that the mobile phone 104 is present.

The POS Issuer installs the POS application 204 into the secure element 106 (e.g., UICC Card) and launches POS enciphering key pair generation in the secure element 106. The POS Issuer receives the public POS key, combines it with the phone number of the mobile phone 104 (MSISDN) and signs the public POS Certificate with the POS Issuer's Secret key. The POS Issuer stores the POS public key certificate (including MSISDN) in the UICC POS Certificate database.

The cardholder inserts in the card terminal 702 the card 102 to be registered with the POS application, and reads the Primary Account Number, the public IC PIN enciphering key, the cardholder's name, etc. The cardholder is verified by the PIN code (PIN2) entered using the keypad of the card terminal 702 and the payment card's Primary Account Number (PAN). The cardholder enters the mobile phone number of the secure element 106, e.g., the POS UICC card (MSISDN). The card terminal 702 or the Card Issuer requests the POS certificate using the MSISDN number. The card terminal 702 or the Card Issuer receives the UICC POS certificate and validates it by using the POS Issuer's public key.

The card terminal 702 generates an unpredictable number, encrypts the number with the public POS key and send it to the POS application 204 on the secure element 106, e.g., UICC card, using the MSISDN number. The POS application 204 receives the encrypted data, decrypts the number, and presents the recovered unpredictable number on the display 704 of the mobile device 104.

The cardholder and owner of the mobile device 104 enters the unpredictable number on the card terminal 702 for proof of having the mobile device 104 with the UICC card corresponding with the MSISDN number. In the alternative, Near Field communication may be used to verify the phone 104 with the POS app 204 on the secure element 106 at the card terminal 702.

The card terminal 702 verifies the sent and user typed unpredictable numbers, and as a result, either proceeds or declines. The card terminal generates the pseudo code (PIN2), signs the POS PIN Certificate (MSISDN, PAN, PIN, PIN2) with a card issuer's secret key and encrypts it with a public POS key. The card issuer sends the encrypted and signed POS PIN Certificate to the secure element 106, e.g., UICC card, using the MSISDN number. The secure element 106 receives the encrypted POS PIN Certificate and decrypts it with its secret POS key, verifies the card issuer's signature, and stores the POS PIN Certificate in the secure element's secure memory. The card issuer then sends the PIN2 code by secure mail to the cardholder's correspondence address.

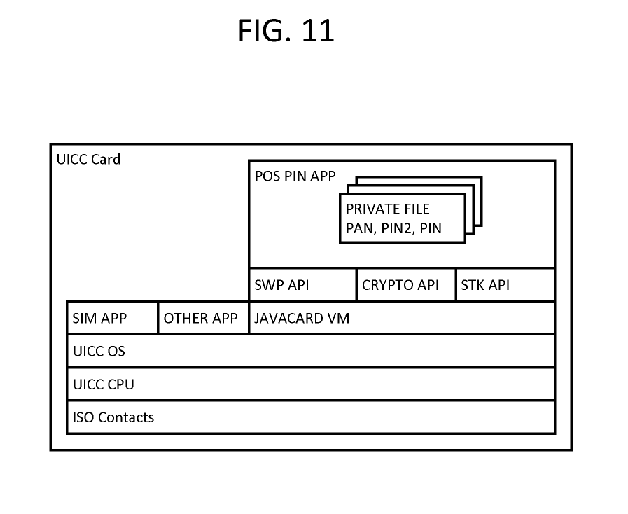

FIG. 11 is a block diagram of one potential implementation of the UICC Card with a secure POS terminal application and PIN Certificate database.

The transaction may be a payment transaction, such as an EMV transaction with corresponding security features, such as unpredictable numbers, transaction counters, challenge-response methods, random padding, PIN code and key enciphering as described in and required by the used transaction protocol.

The payment card 102 can use Near Field Communication protocol or any other similar short distance radio frequency electromagnetic communication protocol, or an optical communication protocol using visible or non-visible wavelength.

The PIN code cardholder verification method is not limited to financial transactions or for use with only a payment card, but can be used with any type of user authentication and verification purposes, for example, physical access control or logging into a web site.

The PIN certificates on the secure element, such as the UICC card, can be securely modified and deleted using either a remote connection or locally.

The PIN code for a specific payment card may be encrypted and signed by a secured system and then transmitted to the POS terminal without using the mobile device 104 as the PIN entry device, but instead using a secure data communication channel from an external secure system. The secure channel can be, for example, via the NFC antenna of the mobile device, or a secure communication over a network.

The present embodiment(s) thus enables secure cardholder verification without entering, and potentially exposing, the actual payment card PIN code by using a non-secure device, such as a mobile phone keypad or touch screen.

Aspects of the present embodiment(s) can also be embodied as software configured to be used with a processor to cause the processor to perform operations, or can be embodied as hardware on one or more connected or unconnected devices. The software can be stored on a non-transistory computer-readable media.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A method for authenticating a user conducting a payment card transaction using a payment card, the method comprising:
comparing, in one or more of a secure element containing secured data including at least one first code and at least one first payment card information associated with the first code, and a mobile device to which the secure element is connected, the first code with a second code provided as an entry at the mobile device to determine whether or not there is a match between the first code and the second code, and comparing the first payment card information with second payment card information of the payment card read from the payment card via a card reader of the mobile device to determine whether or not there is a match between the first payment card information and the second payment card information when the payment card is in the vicinity of the card reader of the mobile device; and
transmitting, by a transmission device from the mobile device, user authentication information for conducting the payment card transaction when it is determined that there is a match between the first code and the second code and it is determined that there is a match between the first payment card information and the second payment card information.

2. The method according to claim 1, wherein the secure element is a Universal Integrated Circuit Card (UICC) connected to the mobile device by being inserted into the mobile device or an embedded secure element (ESE) connected with the mobile device by being embedded within the mobile device.

3. The method according to claim 1, wherein the transmitting the user authentication information comprises one of transmitting a third code that is associated with the first payment card information to be transmitted to a payment processing system for online validation, transmitting the third code to the payment card for a local validation, and transmitting a user verification status indicator to the payment processing system.

4. The method according to claim 1, wherein the secured data is received via one or more of a mobile/cellular network, the Internet, a wireless or wired local area network, a cable connected to the mobile device, a memory card, a short distance communication interface, an embedded camera in the mobile device, a microphone, another audio interface of the mobile device, a keypad of the mobile device, and a touchscreen of the mobile device.

5. The method according to claim 4, wherein the short distance communication interface operates according to one of Near Field Communication (NFC) protocol, Bluetooth© communication protocol, and Infrared communication protocol.

6. The method according to claim 1, wherein the secured data is encrypted.

7. The method according to claim 1, wherein the secured data is used to form a digital certificate, and
the digital certificate is signed by a trusted provider.

8. The method according to claim 1, wherein the secured data is a digital certificate encrypted by a trusted provider.

9. The method according to claim 1, wherein the secured data contains a public key certificate of a trusted provider.

10. The method according to claim 1, wherein the content of the secured data is verified using the public key certificate of the trusted provider.

11. The method according to claim 1, further comprising encrypting the transmitted user authentication information prior to transmission from the transmission device.

12. The method according to claim 1, wherein the transmitted user authentication information is digitally signed by one or more of the mobile device, an Embedded Secure Element, and a Universal Integrated Circuit Card (UICC)/Subscriber Identity Module (SIM) card.

13. The method according to claim 1, wherein the first code is compared with the second code by an authentication application executed by one or more processors at the mobile device.

14. The method according to claim 1, wherein the user authentication information includes a third code associated with the first payment card information.

15. The method according to claim 14, further comprising encrypting the third code before transmitting the third code to one of the payment card and an external authentication service.

16. The method according to claim 15, wherein the first code and the second code are pseudo personal identification number (PIN) codes for user verification using an authentication application, and the third code is a true PIN code for user verification for using the payment card.

17. The method according to claim 1, wherein a transaction authorization application that provides the secured data runs on the secure element, the secured data being stored in a secure memory of the secure element.

18. The method according to claim 1, wherein the secured data is stored in a personal identification number (PIN) certificate containing various types of information associated with the payment card.

19. The method according to claim 1, wherein the second code is provided from one or more stored secured data, each of the stored secured data being associated with a different condition associated with use of the payment card.

20. The method according to claim 19, wherein the different condition for a specific stored secured data of the one or more stored secured data includes one or more of:
a value limit on the transaction associated with the user authentication,
a threshold level of transactions using only the payment card,
the transaction involving currency that is not indicated at an authentication application as domestic currency,
the transaction occurring in a foreign country to a home country of the payment card or a home country of the mobile device,
the transaction being a forced transaction, and
a single-code transaction in which the stored secured code expires after the single-code transaction occurs.

21. The method according to claim 1, wherein the third code is linked to an identifier of the payment card.

22. The method according to claim 1, wherein the payment card is a contactless payment card.

23. The method according to claim 1, wherein the contactless card communicates via short distance communication.

24. The method according to claim 1, wherein a transaction authorization application that provides the user authentication information is provided at the mobile device.

25. A method of enabling a user to conduct a payment card transaction, the method comprising:
receiving an entry of a pseudo personal identification number (PIN) code in connection with a payment card, at a secure element connected with a mobile device;
obtaining user authentication information including a true PIN code associated with the pseudo PIN code; and
transmitting, via a transmission device, the user authentication information confirming user authentication to authorize use of the payment card in a payment transaction, to the payment card or to an external authorization service or system.

26. The method according to claim 25, wherein the obtained user authentication information is obtained at the mobile device at which the pseudo PIN code is entered and transmitted from the mobile device to the payment card.

27. A system for enabling a user to conduct a payment card transaction, the system comprising:
a contactless payment card configured to communicate via short distance communication;
a mobile device including one or more user interface components configured to receive an entry of a second code, and a card reader configured to read information from the payment card;
a secure element configured to communicate with the mobile device, the secure element receiving and storing secured data including at least one first code and at least one first payment card information associated with the first code, and receives the second code from the mobile device, the secure element comprising
one or more processors executing a transaction authorization application, the transaction authorization application obtaining user authentication information when the second code is compared with the stored first code that is associated with the payment card and a match is determined to be made between the first code and the second code, and when the stored first payment card information is compared with second payment card information read from the payment card via the card reader of the mobile device and a match is determined to be made between the stored first payment card information and the second payment card information read from the payment card via the card reader when the payment card is in the vicinity of the card reader of the mobile device; and
a transmission device configured to transmit the user authentication information to one of the payment card and a payment processing system as user verification for conducting a transaction using the payment card with the mobile device.

28. The system according to claim 27, wherein the user authentication information includes a third code, and the transmission device transmits the third code to one of the payment processing system for online validation and the payment card for local validation.

29. The system according to claim 27, wherein the user authentication information includes a user verification status indicator, and the transmission device transmits the user verification status indicator to the payment processing system.

30. The system according to claim 27, wherein the transmission device is provided at the mobile device.
